(19) United States
(12) Patent Application Publication
(10) Pub. No.: US 2006/0059120 A1
(43) Pub. Date: Mar. 16, 2006

(54) Identifying video highlights using audio-visual objects

(76) Inventors: Ziyou Xiong, Urbana, IL (US); Regunathan Radhakrishnan, Quincy, MA (US); Ajay Divakaran, Burlington, MA (US)

Correspondence Address: Patent Department;Mitsubishi Electric Research Laboratories, Inc., 201 Broadway, Cambridge, MA, 02139, US

(21) Appl. No.: 10/928,829

(22) Filed: Aug. 27, 2004

(51) Int. Cl. G06F 17/30

(52) U.S. Cl. 707/3

(57) ABSTRACT

A method identifies highlight segments in a video including a sequence of frames. Audio objects are detected to identify frames associated with audio events in the video, and visual objects are detected to identify frames associated with visual events. Selected visual objects are matched with an associated audio object to form an audio-visual object only if the selected visual object matches the associated audio object, the audio-visual object identifying a candidate highlight segment. The candidate highlight segments are further refined, using low level features, to eliminate false highlight segments.

### FIELDS OF THE INVENTION

This invention relates to analyzing videos, and more particularly to identifying highlight segments in videos.

### BACKGROUND OF THE INVENTION

Event indexing and highlight identifications in videos have been actively studied for commercial application. Many researchers have studied the respective role of visual, audio and textual modality in this domain, specifically for sports videos.

For the visual mode, one method tries to extract bat-swing features based on the video signal, T. Kawashima, K. Tateyama, T. Iijima, and Y. Aoki, “Indexing of baseball telecast for content-based video retrieval,” 1998 International Conference on Image Processing, pp. 871-874, 1998. Another method segments soccer videos into play and break segments using dominant color and motion information, L. Xie, S. F. Chang, A. Divakaran, and H. Sun, “Structure analysis of soccer video with hidden Markov models,” Proc. Intl. Conf. on Acoustic, Speech and Signal Processing, (ICASSP-2002), May 2002, Orlando, Fla., USA; P. Xu, L. Xie, S. F. Chang, A. Divakaran, A. Vetro, and H. Sun, “Algorithms and system for segmentation and structure analysis in soccer video,” Proceedings of IEEE Conference on Multimedia and Expo, pp. 928-931, 2001. Gong et al. targeted at parsing soccer programs, Y. Gong, L. T. Sin, C. H. Chuan, H. Zhang, and M. Sakauchi, “Automatic parsing of TV soccer programs,” IEEE International Conference on Multimedia Computing and Systems, pp. 167-174, 1995. By detecting and tracking the soccer field, ball, players, and motion vectors, they were able to distinguish nine different positions of the play, e.g., mid-field, top-right corner of the field, etc. Ekin et al. analyze soccer videos based on video shot detection and classification, A. Ekin and A. M. Tekalp, “Automatic soccer video analysis and summarization,” Symp. Electronic Imaging: Science and Technology: Storage and Retrieval for Image and Video Databases IV, January 2003.

For the audio mode, Rui et al. detect an announcer's excited speech and ball-bat impact sound in baseball videos using directional audio template matching, Y. Rui, A. Gupta, and A. Acero, “Automatically extracting highlights for TV baseball programs,” Eighth ACM International Conference on Multimedia, pp. 105-115, 2000.

For the textual mode, Babaguchi et al. search for time spans in which events are likely to take place through extraction of keywords from the closed captioning stream, N. Babaguchi, Y. Kawai, and T. Kitahashi, “Event based indexing of broadcasted sports video by intermodal collaboration,” IEEE Transactions on Multimedia, vol. 4, no. 1, pp. 68-75, March 2002. Their method has been applied to index events in American football video.

Because the content of sports videos is intrinsically multimodal, many methods use different information fusion schemes to combine different modality information. In a review paper on different multimodal video indexing techniques, Snoek and Worring categorized many approaches as simultaneous or sequential in terms of content segmentation, statistical or knowledge-based in terms of classification method, and iterated or non-iterated in terms of processing cycle, C. Snoek and M. Worring, “Multimodal video indexing: A review of the state-of-the-art,” Technical Report 2001-20, Intelligent Sensory Information Systems Group, University of Amsterdam, 2001, Intelligent Sensory Information Systems Group, University of Amsterdam, 2001. Applying their categorization method, fusion methods for sports video analysis can be summarized as follows.

Simultaneous or Sequential Fusion

Hanjalic models audience excitement using a function of the following factors from different modalities: the overall motion activity measured at frame transitions; the density of cuts or abrupt shot changes; and the energy contained in the audio track, A. Hanjalic, “Generic approach to highlight detection in a sport video,” in Proceedings of IEEE Intl' Conference on Image Processing, September 2003, Special Session on Sports Video Analysis. Hanjalic derives an ‘excitement’ function in terms of these three parameters in a symmetric, i.e. simultaneous, fashion. On the other hand, Chang et al. primarily used audio analysis as a tool for sports parsing, Y.-L. Chang, W. Zeng, I. Kamel, and R. Alonso, “Integrated image and speech analysis for content-based video indexing,” in Proceedings of the IEEE Intl' Conf. Multimedia Computing and Systems, June 1996. Their goal was to detect touchdowns in American football. A standard template matching of filter bank energies was used to spot the key words ‘touchdown’ or ‘fumble’. A silence ratio was then used to detect ‘cheers’ with the assumption that there is less silence during cheering than during reporter commentary. Vision-based line-markers were used to verify the results obtained from audio analysis.

Statistical or Knowledge-Based Fusion

For statistical fusion, Huang et al. compared four different hidden Markov model (HMM) based methods: direct concatenation of audio and visual features; the product of the HMM classification likelihoods, each of which corresponds to a single modality; an ordered, two-stage HMM; and neural networks that learn the relationships among single-modality HMMs for the task of differentiating advertisements, basketball, football, news, and weather forecast videos, J. Huang, Z. Liu, Y. Wang, Y. Chen, and E. K. Wong, “Integration of multimodal features for video scene classification based on HMM”, in Proceedings of IEEE 3rd Workshop on Multimedia Signal Processing, September 1999. For knowledge-based fusion, Rui et al. use a weighted sum of likelihoods to fuse the excited speech likelihood and ball-bat impact likelihood, Y. Rui, A. Gupta, and A. Acero, “Automatically extracting highlights for TV baseball programs,” Eighth ACM International Conference on Multimedia, pp. 105-115, 2000. Weight factors are derived from a priori knowledge regarding which weight factor receives larger weights. Nepal et al. detect basketball ‘goals’ based on crowd cheer from the audio signal using energy thresholds. They also detect change in motion vector direction using motion vectors and change of scores based on score text detection, S. Nepal, U. Srinivasan, and G. Reynolds, “Automatic detection of ‘goal’ segments in basketball videos,” in Proceedings of the ACM Conf. on Multimedia, 2001.

Iterated or Non-Iterated Fusion

Most fusion techniques are non-iterated. However, in N. Babaguchi, Y. Kawai, and T. Kitahashi, “Event based indexing of broadcasted sports video by intermodal collaboration,” IEEE Transactions on Multimedia, vol. 4, no. 1, pp. 68-75, March 2002, the visual modality and the closed captioning modality are combined to generate semantic index results in an iterated method. The results form an input for a post-processing stage that uses the indices to search the visual modality for the specific time of occurrence of the semantic event.

Most of the prior art systems focus on a particular sport for highlights extraction. For example, Rui et al. for baseball; Nepal et al. for basketball; Xie et al., and Xu et al. and Gong et al. for soccer. The work by Hanjalic can be made sports-independent. However, the audio and visual features in his method are at a relatively low level. This makes it difficult to map the features to semantic concepts such as sports highlights. When such an ‘excitement’ function is applied to the entire game content, the false alarms rate of his method is relatively high.

The following U.S. patents and patent applications also describe methods for extracting features and detecting events in multimedia, and summarizing multimedia, U.S. patent application Ser. No. 09/518,937, “Method for Ordering Data Structures in Multimedia,” filed Mar. 6, 2000 by Divakaran, et al., U.S. patent application Ser. No. 09/610,763, “Extraction of Semantic and Higher Level Features from Low level Features of Multimedia Content,” filed on Jul. 6, 2000, by Divakaran, et al., U.S. Pat. No. 6,697,523, “Video Summarization Using Motion and Color Descriptors,” issued to Divakaran on Feb. 24, 2004, U.S. Pat. No. 6,763,069, “Extraction of high level features from low level features of multimedia content,” U.S. patent application Ser. No. 09/845,009, “Method for Summarizing a Video Using Motion Descriptors,” filed on Apr. 27, 2001 by Divakaran, et al., U.S. patent application Ser. No. 10/610,467, “Method for Detecting Short Term Unusual Events in Videos,” filed by Divakaran, et al. on Jun. 30, 2003, and U.S. patent application Ser. No. 10/729,164, “Audio-visual Highlights Detection Using Hidden Markov Models,” filed by Divakaran, et al. on Dec. 5, 2003. All of the above are incorporated herein by reference.

It should be noted that most prior art methods are based on low level features, which are error prone.

### SUMMARY OF THE INVENTION

In a method according to the invention, audio information from a video is subjected to audio object detection to yield audio objects. Similarly, visual information in the video is subjected to visual object detection to yield visual objects. For unknown video content with audio objects and visual objects, the method according to the invention detects whether there are objects in the video that belong to a particular classification. The detection results are used to classify the video as a particular genre. Then, using the audio objects, the visual objects, and the video genre, the objects are matched with one another, and the matched audio-visual objects identify frames of candidate highlight segments in the video. False candidate highlight segments are eliminated using refined highlight recognition resulting in accepted selected ones of the candidate highlight segments as actual highlight segments.

### BRIEF DESCRIPTION OF THE DRAWINGS

FIG. 1 is a block diagram of a method for identifying highlight segments from a video according to the invention;

FIGS. 2A-2C shows examples of the visual objects;

FIG. 3 is a precision-recall graph for the visual objects of FIGS. 2A-2C;

FIG. 4 is a block diagram of a video camera setup for a soccer game;

FIG. 5 are images of goal post objects for a first view;

FIG. 6 are images of goal post objects for a second view; and

FIG. 7 is a block diagram of matched objects and highlight segments.

### DETAILED DESCRIPTION OF THE PREFERRED EMBODIMENT

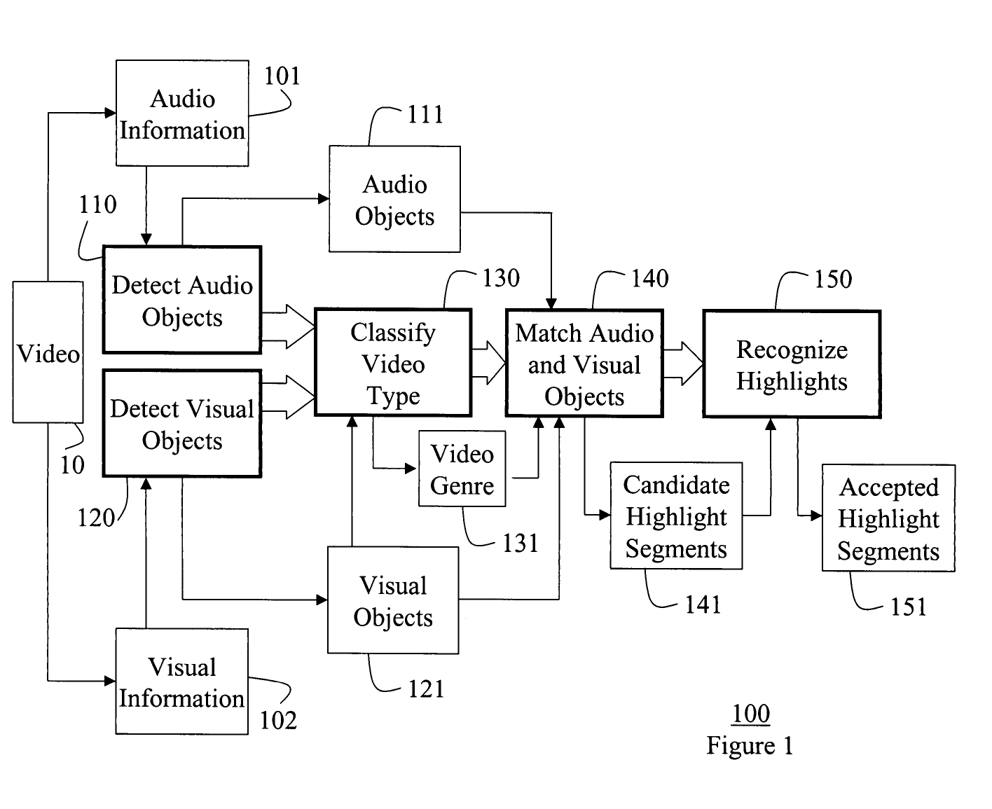

FIG. 1 shows a method 100 for identifying highlight segments 151 in a video 10 according to the invention. Audio information 101 from the video 10 is subjected to audio object detection 110 yielding audio objects 111. Similarly, visual information 102 of the video is subjected to visual object detection 120 yielding visual objects 121. The audio object indicates a sequence of consecutive audio frames that form a contiguous audio segment. The visual object indicates a sequence of video frames that form a contiguous visual segment.

For the goal of one general framework for all video, we use the following processing strategy. For unknown video content with audio objects 111 and visual objects 121, we detect whether there are objects in the video content that belong to a particular classification. The detection results enable us to classify 130 the video genre 131. The video genre indicates a particular genre of video, e.g., soccer, golf, baseball, football, hockey, basketball, tennis, etc.

Audio objects 111 and visual objects 121 are matched 140 to form audio-visual object. The audio-visual object can be used to identify a beginning and an end of a highlight segment 141 in the video according to the invention. The beginning is the first frame in the audio-visual object, and the end is the last frame in the audio-visual object.

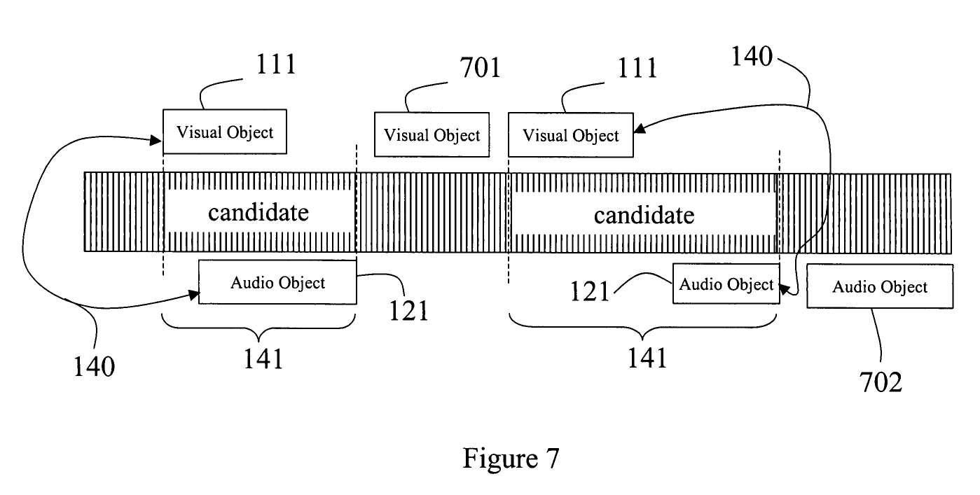

As shown in FIG. 7, using the audio objects 111, the visual objects 121, and the video genre 131, the audio and visual objects are matched 140 with one another to form the audio-visual objects that identifies frames of candidate highlight segments 141.

We eliminate false candidate segments using highlight refinement 150 described in more detail below. This results in the accepted actual highlight segments 151. As an advantage, the highlight refining 150 only operates on a much smaller portion of the video.

Audio Event Detection

The audio information of a sports video typically includes commentator and audience reactions. For example, total silence precedes a golf putt, and loud applause follows a successful sinking of the putt. In other sports, applause and cheering typically follow scoring opportunities or scoring events. These reactions can be correlated with highlight segments of the games, and can be used as audio objects 111. Applause and cheering are example audio objects. Note, these objects are based on high level audio features of the video, and have a semantic meaning, unlike low level features. The audio objects can be in the form of standardized MPEG-7 descriptors as known in the art, which can be detected in real-time.

Visual Event Detection

Instead of searching for motion activity pattern, color patterns or cut density patterns, or other low level features, as in prior art methods, we identify specific visual objects that are highly correlated with the highlight event of a particular sport. The visual objects have a semantic meaning. For example in baseball videos, we detect the squatting catcher waiting for the pitcher to deliver the ball. For golf games, we detect the player bending over to putt the golf ball. For soccer, we detect the goalposts. Correct detection of these visual objects eliminates the majority of the video that is not related to highlight segments.

Visual Object Detection

We use a visual object detection process that can be applied to any type of visual object, P. Viola and M. Jones, “Robust real-time object detection,” Second International Workshop on Statistical and Computational Theories of Vision-Modeling, Learning, Computing and Sampling, July 2001, and U.S. patent application Ser. No. 10/200,464, “System and Method for Detecting Objects in Images,” filed by Viola et al., on Jul. 22, 2002, incorporated herein by reference.

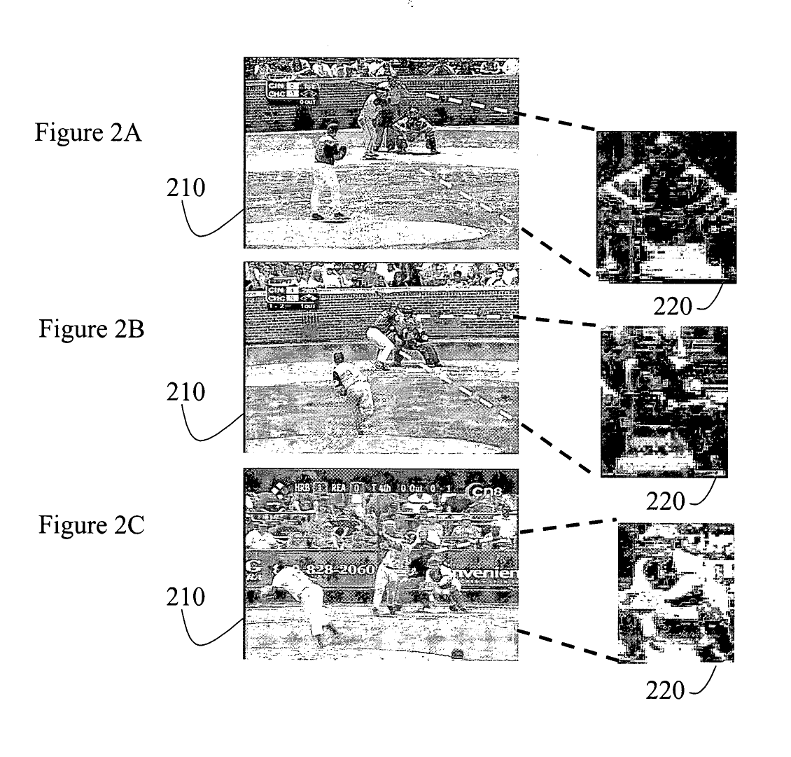

For example, we make the following observation for a baseball video. At the beginning of a baseball pitch, the video includes the frontal view of the catcher squatting to catch the ball. FIG. 2 shows some examples 210 of these images with the cutouts of the catchers 220. Positive examples with a catcher and negative examples without a catcher are used to train the object detection method. A learned catcher model is then used to detect catcher objects from all the video frames in the video content. Similarly, any object can be used to teach the object detection method, e.g., nets, goals, baskets, etc. If the specific object is detected in a video frame, a binary number one is assigned to this frame, otherwise, a zero is assigned.

We use the following technique to eliminate false detections of events. For every frame in a candidate highlight segment, we look at a range of frames, e.g., the fourteen frames before and after the current frame. If the number of frames that includes the object is above a predetermined threshold, then we declare the current frame as a part of a valid highlight segment. Otherwise, we declare the current frame as a frame in an invalid highlight segment. By varying the threshold, e.g., 30% of the total number of frames in the range, we can compare the number of detections with those in the ground truth set. The frames in the ground truth set are manually marked.

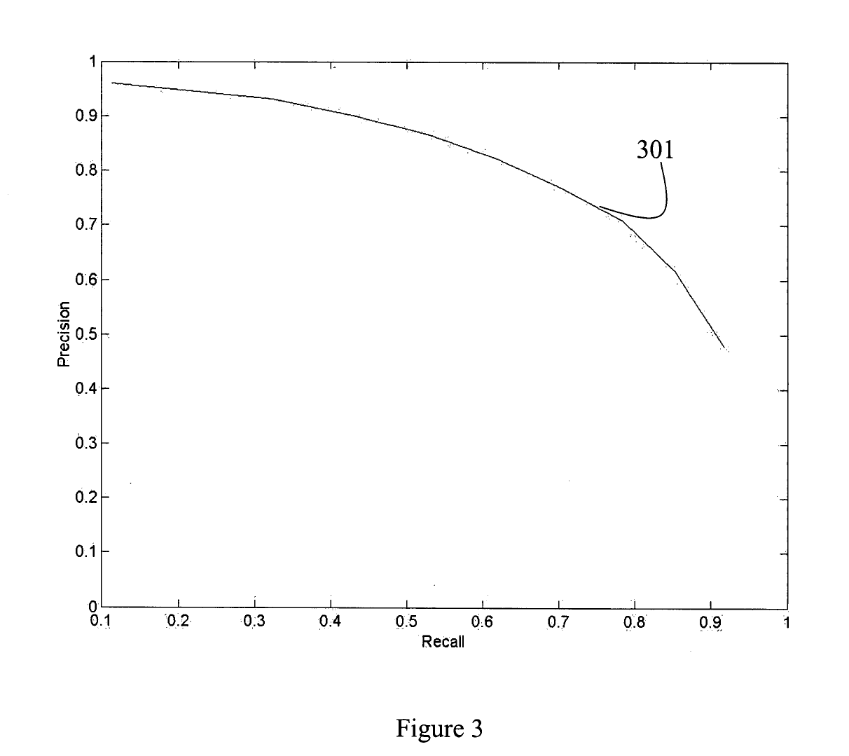

FIG. 3 shows a precision-recall curve 301, and Table A includes the detailed results for detecting catcher objects according to the invention.

TABLE A

| Threshold | Precision | Recall |
|---|---|---|
| 0.1 | 0.480 | 0.917 |
| 0.2 | 0.616 | 0.853 |
| 0.3 | 0.709 | 0.784 |
| 0.4 | 0.769 | 0.704 |
| 0.5 | 0.832 | 0.619 |
| 0.6 | 0.867 | 0.528 |
| 0.7 | 0.90 1 | 0.428 |
| 0.8 | 0.930 | 0.323 |
| 0.9 | 0.947 | 0.205 |
| 1.0 | 0.960 | 0.113 |

As another example, we make use of the following two observations from soccer videos. For most of the interesting plays, such as goals, corner kicks, penalty kicks, the goalposts are almost always in the view. Hence, detection of the goal post object can detect interesting plays with high accuracy.

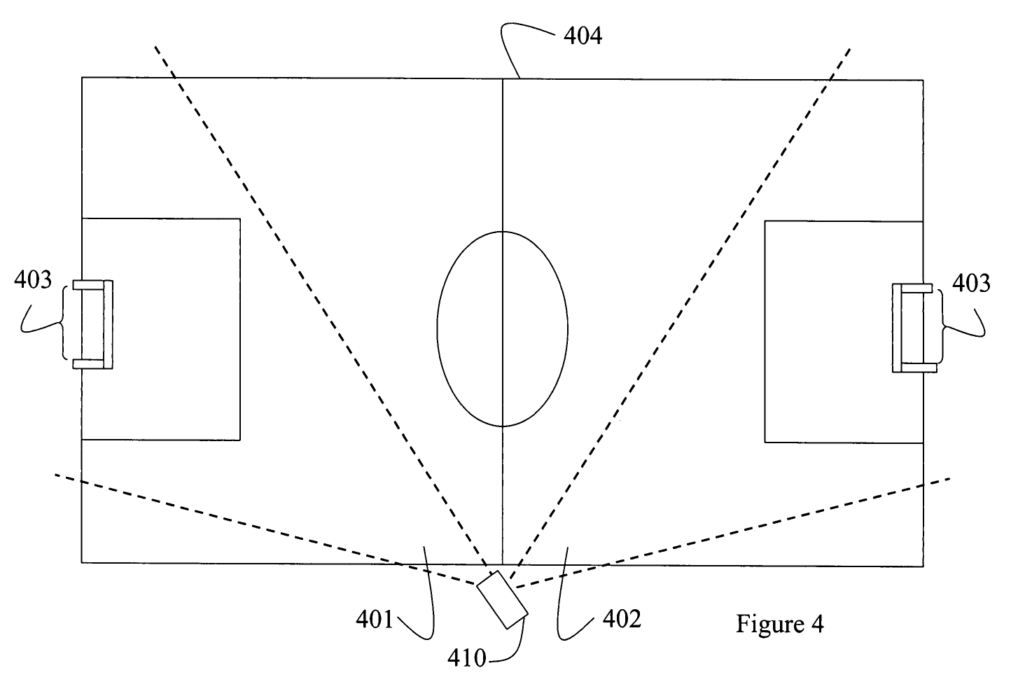

As shown in FIG. 4, there are mainly two views 401-402 of the goal posts that we need to detect. To illustrate this, we show a typical camera setup for broadcasting soccer games. A camera 410 is usually positioned to one side of the center of the field 404. The camera pans back and forth across the field, and zooms on special targets. Because the distance between the camera 410 and the goal posts 403 is much larger than the size of the goal itself, there is little change in the pose of the goalposts during the game, irrespective of the camera pan or zoom. These two typical views to the left 401 and to the right 402 of the goalposts 403 on a soccer field 404 are shown in FIG. 4.

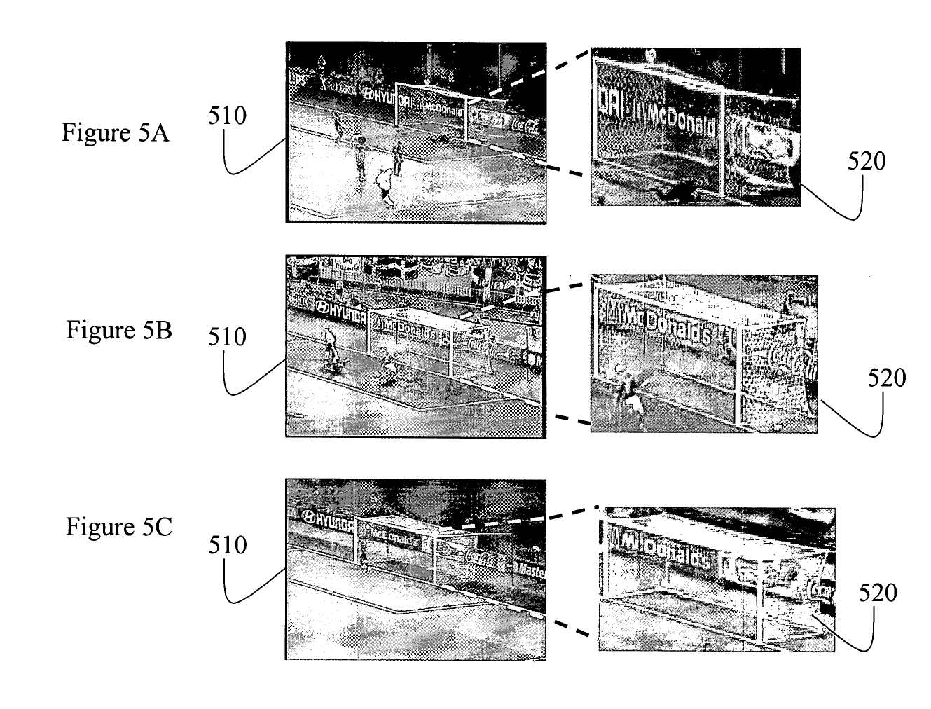

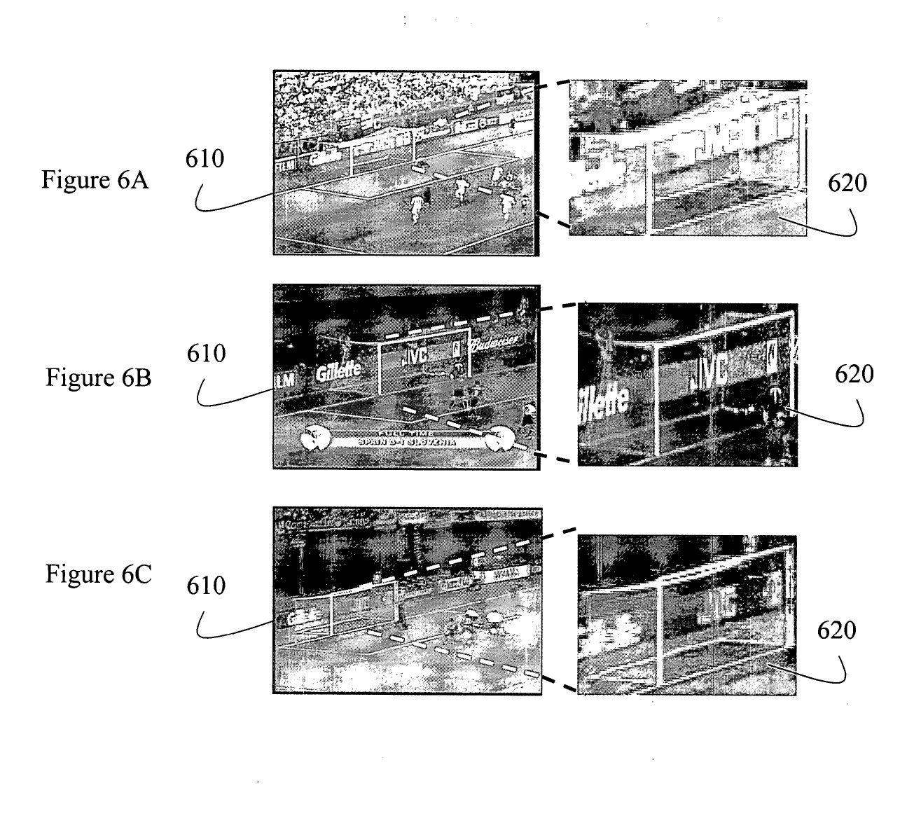

Some example images from the right side 510 of the field with cutouts of the goalposts 520 and images from the left side 610 of the field with cutouts of the goalposts 620 are shown in FIG. 5 and FIG. 6, respectively.

Audio-Visual Object Matching

As shown in FIG. 7, if frames indicated by a visual object overlap with frames indicated by a matching audio object by a large margin, e.g., the percentage of overlapping is greater than 50%, then we form an audio-visual object that identifies a candidate ‘highlight’ segment 141 spanning the frames indicated by the beginning of the audio visual object to the end of the audio-visual object.

Otherwise, we associate the visual object sequence with a nearest following audio object sequence, if the duration between the two sequences is less than a duration threshold, e.g., the average duration of a set of training ‘highlight’ segments from baseball games. It should be noted that the order of objects can be reversed. For example, in golf, the applause happens after putt is made, and in soccer loud cheering while a scoring opportunity is developing may be followed by a shot of the goal.

Frames related to unassociated objects 701-702, that is, objects that cannot be matched and frames unrelated to any object, are discarded.

Refined Highlight Segment Classification

In the method according to the invention, sports videos are divided into candidate “highlight” segments 141 according to audio and visual events contained within the video content. Candidate highlight segments delimited by the audio objects and visual objects are quite diverse. Additionally, similar objects may identify different events. Furthermore, some of the candidate segments may not be true highlight segments. For example, golf swings and golf putts share the same audio objects, e.g., audience applause and cheering, and visual objects, e.g., golfers bending to hit the ball. Both of these kinds of golf highlight events can be found by the audio and visual objects detection. To support the task of retrieving specific events such as “golf swings only” or “golf putts only,” we use models of these events based on low level audio-visual features. For example, for golf, we construct models for golf swings, golf putts and non-highlight events, i.e., neither swings nor putts, and use these models for highlight classification (swings or putts) and verification (highlights or non-highlights).

The candidate highlight segments located after the audio objects and visual marking and the correlation step are further separated using refinement techniques. For baseball, there are two major categories of candidate highlight segments, the first being “balls or strikes” in which the batter does not hit the ball, the second being “ball-hits” in which the ball is hit. These two categories have different color patterns. In the first category, the view of the camera remains fixed at the pitch scene, so the variance of color distribution over time is relatively low. In the second category, in contrast, the camera follows the ball or the runner, so the variance of color distribution over time is relatively high.

We construct a sixteen-bin color histogram, using the hue component in a HSV color space, from every video frame of each of the candidate highlight segment. Every candidate highlight segment is represented by a matrix of size L×16, where L is the number of frames in the segment. We denote this matrix as the “color histogram matrix”. The histogram is constructed on a ‘clip’ level. A clip is also known as a ‘shot’, i.e., a contiguous sequence of frames, from shutter open to shutter close. We use the following process to refine the classification.

1. For each row in each color histogram matrix, determine a ‘clip level’ mean vector, and a ‘clip level’ standard deviation (STD) vector.

2. Cluster all the candidate highlight segments based on their ‘clip level’ STD vectors into two clusters, using e.g., k-means clustering.

3. For each cluster, determine a ‘cluster level’ mean vector, and a ‘cluster level’ STD vector, over each rows of each color histogram.

4. If the value in a color bin of the ‘clip level’ mean vector is outside the three δ range of the ‘cluster level’ mean vector, where δ is the STD of the ‘cluster level’ STD vector at the corresponding color bin, remove the frame from the candidate highlight segment.

We use the high level visual object detection, e.g., the baseball catcher, to locate visual objects in the video. In parallel, we use the high level audio classification to locate audio objects in the video. The candidate highlight segments are then further grouped into finer-resolution segments, using low level color or motion information. During the grouping phase, many of the misidentified frames can be eliminated. It should be noted, that this processing of low level features only consider frames in candidate segments.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for identifying highlight segments in a video including a sequence of frames, comprising:
detecting audio objects identifying frames associated with audio events in the video;
detecting visual objects identifying frames associated with visual events;
matching selected visual objects with an associated audio objects; and
forming an audio-visual object only if a particular selected visual object matches a particular associated audio object, the audio-visual object identifying a candidate highlight segment.

2. The method of claim 1, further comprising:
classifying the visual objects to determine a genre of the video.

3. The method of claim 2, in which the matching is based on the genre.

4. The method of claim 2, in which the genre is selected from the group consisting of soccer, golf, baseball, football, hockey, basketball, and tennis.

5. The method of claim 1, in which each audio object and each visual object has a semantic meaning.

6. The method of claim 1, in which the visual objects and the audio objects are detected in real-time.

7. The method of claim 1, in which the visual object is selected from the group consisting of goal posts, baseball catcher, golfer and net.

8. The method of claim 1, in which the frames of the matching visual object and audio object overlap at least fifty percent.

9. The method of claim 1, further comprising
refining the candidate audio-visual objects to eliminate false audio-visual objects.

10. The method of claim 1, in which the matching visual object and visual object are separated by a length of time that is less than a predetermined threshold.

10. The method of claim 9, in which the refining considers low level features of the video.
